(19) United States
(12) Patent Application Publication
(10) Pub. No.: US 2015/0079246 A1
(43) Pub. Date: Mar. 19, 2015

(54) Candy Bar

(71) Applicant: James Turner, Olive Branch, MS (US)

(72) Inventor: James Turner, Olive Branch, MS (US)

(21) Appl. No.: 14/027,224

(22) Filed: Sep. 15, 2013

(51) Int. Cl. A23G 1/54; A23P 1/12

(52) U.S. Cl. CPC A23G 1/54; A23P 1/12; A23V 2002/00
USPC 426/281; 426/660

(57) ABSTRACT

A process for making a candy bar that includes a first substance and a second substance wherein the second substance is either injected into the first substance or coated over the first substance. The candy bar includes a licorice material that is manufactured from a syrup concoction that includes a coconut oil of a defined percentage. Subsequent to the completion of the manufacturing of the first substance, the candy bar is finished to create one of two embodiments. A second substance, chocolate, is injected into the first substance to create the first embodiment. To create the second embodiment of the candy bar, the second substance, chocolate, is coated over the first substance. The second substance, chocolate, is manufactured to have a different melting point for each of the two aforementioned embodiments.

### FIELD OF INVENTION

The present invention relates generally to confectionary products, more specifically but not by way of limitation, a novel candy bar manufactured from two distinct materials.

### BACKGROUND

Millions of individuals regularly snack on various food items as part of their regular diet or as a treat during the day. Individuals consume snacks from a variety of categories such as but not limited to fruit, vegetables, proteins or sweets. A popular snack category enjoyed by many individuals are sweets. Sweets range from hard candies such as but not limited to lollipops to chocolate bars. Those skilled in the art are aware that numerous types of candy bars are commercially available. Many types of candy bars are manufactured using sweeteners, lipids, emulsifiers and protein matter such as but not limited to nuts. Candy bars are also manufactured using fruit pieces such as but not limited raisins or cherries. The latter type of candy bar are typically paired with chocolate either being coated therewith or being manufactured such that the candy bar is a mixture of the fruit and nut pieces with the chocolate.

While numerous candy bar options exist, there are no existing candy bar embodiments that combine a licorice material with a chocolate material. The manufacturing process for licorice and chocolate are very unique and the instant invention provides a process to produce a candy bar that is manufactured utilizing the two aforementioned materials to produce a desirable treat.

### SUMMARY OF THE INVENTION

It is the object of the present invention to provide a candy bar that is manufactured to include a licorice and a chocolate material.

Yet another object of the present invention is to provide a candy bar containing a mixture of licorice and chocolate wherein in one embodiment the chocolate material is provided as a coating.

A further object of the present invention is to provide a candy bar having a mixture of licorice and chocolate wherein in an alternative embodiment the chocolate comprises the core of the candy bar.

Still a further object of the present invention is to provide a candy bar that utilizes a mixture of licorice and chocolate wherein in the embodiment having the exterior coating of chocolate the chocolate is in a semi-solid state.

An additional object of the present invention is to provide a candy bar manufactured from a mixture of licorice and chocolate wherein in the embodiment having the chocolate core, the chocolate is in a liquid state.

Still another object of the present invention is to provide a candy bar manufactured from a mixture of chocolate and licorice wherein the candy bar is provided in several different sizes.

A further object of the present invention is to provide a candy bar that is manufactured from a combination of licorice and chocolate wherein the licorice is flavored with a plurality of natural flavors.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a diagrammatic sketch of a first embodiment of the present invention; and

FIG. 2 is a diagrammatic sketch of an alternative embodiment of the present invention; and

FIG. 3 is a flow chart of the process of making the present invention.

### DETAILED DESCRIPTION

Referring now to the drawings submitted herewith, wherein various elements depicted therein are not necessarily drawn to scale and wherein through the views and figures like elements are referenced with identical reference numerals, there is illustrated a candy bar 100 constructed manufactured according to the procedures of the present invention.

The candy bar 100 further includes a first material 5 and a second material 10. The first material 5 is a licorice material. The licorice material 5 is manufactured utilizing a cornstarch molding process. In step 200, the cornstarch molding process includes providing at least one tray having a plurality of cylindrical shaped molds is filled with cornstarch. Those skilled in the art will recognize that numerous different shapes and sizes of molds could be utilized to in the tray to produce a candy bar 100 of a different shapes and sizes. In step 202, cornstarch is utilized to coat the molds of the tray. The cornstarch will provide a coating for the licorice finished product to substantially inhibit the licorice from sticking to both the tray molds and other licorice pieces during packaging. In step 204, a syrup is manufactured. The syrup contains a mixture of molasses and coconut oil. While varying percentages of coconut oil are contemplated within the scope of the present invention, good results have been achieved utilizing a coconut oil percentage within a range of five to ten percent. This range provides the desired elasticity while providing an improved mouth-feel to a consumer of the candy bar 100 due to the coconut oils properties that consist of medium chain fatty acids that facilitate a semi-solid phase at room temperature. Additionally, the coconut oil maintains its structure during the heating process of the syrup over other common oils that are used during the manufacturing of licorice. Many oils such as vegetable oil are broken down during high heat processes. In step 206, the syrup mixture is cooked to what is commonly known as a soft-ball stage. As is known in the art, the soft-ball stage of candy cooking occurs when the syrup begins to form a soft more viscous material but not yet hard. In step 208, flour, sweetener and flavoring are added to the syrup in the soft-ball stage. In the preferred embodiment, a flour such as but not limited to cake flour or other similarly fine ground flour is utilized to blend into the syrup mixture. The finer ground flour provides for an improved texture of the finished candy bar 100. For the flour, levels of two to six percent of the total volume of syrup are added. This level provides for the desired consistency once the candy bar 100 has been cured. Additionally, during step 208 sweeteners and flavorings are added. It is preferred that warm liquid cane sugar is added to an amount equivalent to ten percent. For example but not by way of limitation, if a batch of syrup in step 204 is being manufactured at a volume of 1000 liters, it is desirable within the scope of the present invention to add 100 liters of warm liquid cane sugar. This percentage provides the desired sweetness of the candy bar 100 and the use of liquid sugar ensures a smooth consistency of the finished candy bar 100. Conventional licorice utilizes powdered sugar or granular sugar and must be cooked sufficiently in order to properly dissolve the granules. The use of liquid sugar reduces the cooking time as well as improving the texture of the finish candy bar 100. Still continuing with step 208, a desired flavor and coloring is added. Those skilled in the art will recognize that numerous different flavors could be added such as but not limited to cherry or raspberry. Additionally, it is contemplated within the scope of the present invention that the flavoring agents are added to produce a desired flavor profile and that no specific concentration of flavoring agent is required. In step 210, the mixture is cooled to approximately one hundred and fifty degrees and then extruded through a plate having an annular aperture with a diameter that is similar in size to the width of the molds in the tray. As the mixture is extruded, it is cut into lengths that are generally equal to the lengths of the molds of the tray. The cut lengths of extruded mixture are placed in the molds of the tray in step 212. In step 212, the final curing of the licorice material takes place. As the final curing of the licorice material takes place the mixture begins to harden so as to form a more waxy consistency. Subsequent the completion of the curing process the cured pieces are removed from the molds in the tray.

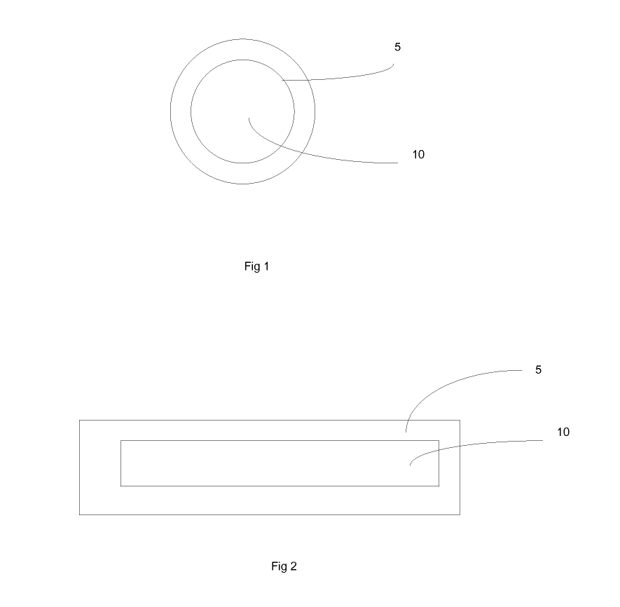

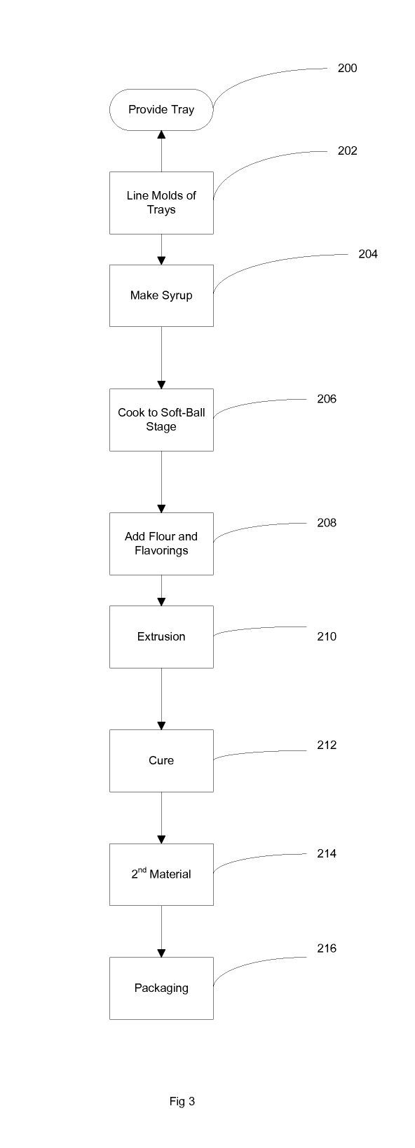

In step 214, the second material 10 is added to finish the manufacturing of the candy bar 100. The second material 10 of the candy bar 100 is chocolate. As shown in the Figures submitted herewith, there are two embodiments of the candy bar 100 wherein the embodiments utilize the second material 10 either as a coating or as a filling. For the embodiment illustrated in FIG. 2, the second material 10 is injected into the completed first material 5. This is accomplished through the utilization of appropriate equipment having a reservoir, pumping system and needle so as to facilitate the injection of the second material(chocolate) into the finished first material(licorice). In this embodiment, it is preferred that the chocolate is manufactured with a process such that the fat content is higher so as to produce a lower melting point wherein the approximate melting point is eighty degrees. This provides for a desired consistency of the filling during consumption of the candy bar 100. A second material having a lower fat content and thus a higher melting point does not provide the desired consistency for the embodiment of the candy bar 100 illustrated in FIG. 2.

In step 214, the alternative embodiment of a coated candy bar 100 can also be accomplished. For a coated candy bar 100, the first material 5 is substantially covered with the second material 10. For this embodiment the second material 10, chocolate, is manufactured using a process commonly known as Pickering emulsion. This process reduces the fat content of the chocolate so as to increase the melting point. During the Pickering emulsion process, the natural fats of the chocolate are replaced with fruit juice droplets. As the fat is removed, the melting point of the chocolate is increased. The fruit juice utilized during the Pickering emulsion process must be the same as the flavoring agent added in step 208. For example but not by way of limitation, if a cherry flavoring agent was utilized in step 208, cherry juice must be utilized in step 214. This provides for a consistency of flavor profile as the chocolate will inherit some of the fruit flavor during the Pickering emulsion process. This process is utilized to remove the fat content of chocolate such that the melting point of the chocolate is approximately 104 degrees.

In step 216, the completed candy bar 100 is packaged into a desired carton and/or bag. Those skilled in the art will recognize that the candy bar 100 could be packaged in numerous different quantities.

While preferred embodiments of the candy bar 100 have been disclosed herein it is contemplated within the scope of the present invention that variations of flavors, sizes and shapes could be manufactured and not depart from the scope of the present invention.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A process for producing a candy bar comprising of a first substance and a second substance comprising the steps of:
providing at least one tray, said at least one tray having a plurality of molds;
making a syrup, wherein the syrup consists of a mixture of molasses and an oil, wherein the syrup is the first material;
cooking the syrup to a soft-ball stage;
adding flour to the syrup;
adding sweetener to the syrup;
adding at least one flavoring agent to the syrup;
cooling the mixture;
extruding the mixture;
curing the mixture;
adding the second substance; and
wherein the second substance is either coated substantially over the first substance or injected thereinto.

2. The process for producing a candy bar as recited in claim 1, wherein the syrup consists of 5 to 10% oil.

3. The process for producing a candy bar as recited in claim 2, wherein the oil is coconut oil.

4. The process for producing a candy bar as recited in claim 3, wherein the sweetener is liquid cane sugar.

5. The process for producing a candy bar as recited in claim 4, wherein the second substance is chocolate.

6. The process for producing a candy bar as recited in claim 5, wherein the step of cooling the mixture further includes cooling the mixture to a temperature of 150 degrees.

7. The process for producing a candy bar as recited in claim 6, wherein the chocolate second substance has a melting point of approximately 104 degrees.

8. A process for producing a candy bar comprising of a first substance and a second substance comprising the steps of:
providing a tray, said tray having a plurality of molds;
making a syrup, wherein the syrup consists of a mixture of molasses and an oil, wherein the syrup is the first material;
cooking the syrup to a soft-ball stage;
adding flour to the syrup, wherein the flour added is added to be a total of 2 to 6 percent of the total volume of the syrup;
adding sweetener to the syrup, wherein the sweetener is in liquid form;
adding at least one flavoring agent to the syrup;
cooling the mixture;
extruding the mixture, wherein the extruding the mixture occurs subsequent the mixture reaching 150 degrees;
curing the mixture;
adding the second substance; and
wherein the second substance is either coated substantially over the first substance or injected thereinto.

9. The process for producing a candy bar as recited in claim 8, wherein the step of making a syrup further includes adding coconut oil, wherein the coconut oil is added to be within 5 to 10 percent of the total volume of the syrup.

10. The process for producing a candy bar as recited in claim 9, wherein the liquid sweetener is added at a volume that is approximately 10 percent of the total volume of the syrup.

11. The process for producing a candy bar as recited in claim 10, and further including the step of injecting the first substance with the second substance.

12. The process for producing a candy bar as recited in claim 11, wherein the second substance is chocolate.

13. The process for producing a candy bar as recited in claim 12, wherein the melting point of the chocolate is approximately 80 degrees.

14. The process for producing a candy bar as recited in claim 13, and further including the step of lining the tray with cornstarch.

15. A process for producing a candy bar comprising of a first substance and a second substance comprising the steps of:
providing a tray, said tray having a plurality of molds, said plurality of mold being generally linear in manner, said plurality of molds further being lined with cornstarch;
making a syrup, wherein the syrup consists of a mixture of molasses and an oil, wherein the syrup is the first material, wherein the oil is coconut oil;
cooking the syrup to a soft-ball stage;
adding flour to the syrup, wherein the flour added is added to be a total of 2 to 6 percent of the total volume of the syrup, wherein the flour is cake flour;
adding sweetener to the syrup, wherein the sweetener is in liquid form;
adding a flavoring agent to the syrup;
cooling the mixture;
extruding the mixture, wherein the extruding the mixture occurs subsequent the mixture reaching 150 degrees;
curing the mixture;
adding the second substance, wherein the second substance is chocolate, wherein the second substance is added to create a first embodiment and a second embodiment of the candy bar.

16. The process for producing a candy bar as recited in claim 15, and further including the step of injecting the second substance into the first substance.

17. The process for producing a candy bar as recited in claim 16, wherein the second substance has a melting point of approximately 80 degrees in the first embodiment of the candy bar.

18. The process for producing a candy bar as recited in claim 17, and further including the step of reducing the fat content of the second substance, wherein the reduced fat second substance is utilized to create the second embodiment of the candy bar.

19. The process for producing a candy bar as recited in claim 18, wherein the melting point of the second substance to create the second embodiment is approximately 104 degrees.

20. The process for producing a candy bar as recited in claim 19, and further including the step of coating the first substance with the second substance to create the second embodiment of the candy bar.
